(19) United States
(12) Patent Application Publication
(10) Pub. No.: US 2026/0001976 A1
(43) Pub. Date: Jan. 1, 2026

(54) A PROPYLENE-ETHYLENE RANDOM COPOLYMER FOR PIPE APPLICATIONS

(71) Applicant: BOREALIS AG, Vienna (AT)

(72) Inventors: Jingbo Wang, Linz (AT); Markus Gahleitner, Linz (AT); Klaus Bernreitner, Linz (AT); Pauli Leskinen, Porvoo (FI); Jani Aho, Porvoo (FI)

(21) Appl. No.: 18/881,919

(22) PCT Filed: Jul. 11, 2023
(86) PCT No.: PCT/EP2023/069111

§ 371 Date: Jan. 7, 2025

(30) Foreign Application Priority Data
Jul. 11, 2022 (EP) 22 184 103.4

(51) Int. Cl. C08F 210/16; C07F 17/00

(52) U.S. Cl. CPC C08F 210/16; C07F 17/00; C08F 2800/10

(57) ABSTRACT

A monophasic propylene-ethylene random copolymer composition (R-PP), having an MFR₂ of 0.01 to 1.00 g/10 min, a C2 content of 1.5 to 7.5 mol-%, a Tm of 120 to 150° C., a content of 2,1-regiodefects, of 0.05 to 1.20 mol-%; and Mw/Mn of 2.00 to 5.00.

### FIELD OF THE INVENTION

The present invention relates to a monophasic propylene-ethylene random copolymer composition (R-PP), a process for obtaining the monophasic propylene-ethylene random copolymer composition (R-PP), and articles comprising the monophasic propylene-ethylene random copolymer composition (R-PP).

### BACKGROUND TO THE INVENTION

Polypropylene, in particular propylene random copolymers, are versatile synthetic polymers that combine beneficial mechanical properties with desirable processability. These beneficial properties have led to applications of polypropylene in films, automotive articles, hygiene products and pipes, to name just a few.

Polypropylene has long been employed in pipe production, due to the impressive resistance to physical damage (at high and low temperatures), resistance to corrosion and chemical leaching and for the ability of polypropylene pipes to be joined by heat fusion, rather than gluing. Despite the numerous advantages, production of polypropylene for pipe applications does have its limitations.

Polypropylene for pipe applications must necessarily have relatively high molecular weight (such as MFR₂ of below about 0.50 g/10 min), in order to achieve the desired mechanical properties. Many catalysts, in particular single site catalysts, do not allow such high molecular weights to be reached, irrespective of the amount of hydrogen (i.e. molecular weight control agent) employed in the polymerization process. A further issue stems from the sensitivity of single site catalysts to hydrogen (i.e. molecular weight control agent), meaning that small differences in the amount of hydrogen may cause considerable fluctuations in the polymerization process.

Whilst Ziegler-Natta catalysis may solve many of these issues, other problems, including high extractable content and poor long-term pressure performance, mean that this strategy does not fully address the need for improved polypropylene compositions for pipe applications.

EP 3 567 061 A1 discloses trimodal propylene-1-hexene random copolymers for pipe applications, wherein the inventive compositions couple impressive mechanical properties with high comonomer incorporation. The comonomer used, 1-hexene, increases the cost and complexity of producing said compositions.

EP 2 788 181 A1 discloses a propylene-ethylene-1-hexene copolymer having similar mechanical and rheological properties to the comparative copolymers, with some limited improvement shown in pipe properties such as impact testing and internal pressure resistance. It suffers, however, from similar drawbacks as the previous case.

EP 3 147 324 A1 discusses the effect of adding of a long-chain branched propylene homopolymer to propylene random copolymer compositions (e.g. Borealis grade RA130E) to improve the pressure resistance. The production of long-chain branched propylene homopolymer, however, requires a separate reactive modification step, again adding to the cost and complexity of producing said compositions.

Although significant strides have been made in the field of polypropylene pipe materials, further compositions simultaneously satisfying the requirements for low extractable content and impressive mechanical properties, in particular long-term pressure resistance, are required.

### SUMMARY OF THE INVENTION

The present invention is based upon the finding that specific propylene-ethylene copolymers, produced using single-site catalysis, are capable of achieving a balance of low melt flow rates (MFR₂), low extractable content (e.g. XCS content) and impressive long-term pressure resistance.

In a first aspect, the present invention is directed to a monophasic propylene-ethylene random copolymer composition (R-PP), having:
i) a melt flow rate (MFR₂), determined according to ISO 1133 at 230° C. at a load of 2.16 kg, in the range from 0.01 to 1.00 g/10 min;
ii) an ethylene content (C2), as determined by ¹³C-NMR spectroscopy, in the range from 1.5 to 7.5 mol-%;
iii) a melting temperature (Tm), determined according to DSC analysis, in the range from 120 to 150° C.;
iv) a content of 2,1-regiodefects, as determined by quantitative ¹³C-NMR spectroscopy analysis, in the range from 0.05 to 1.20 mol-%; and
v) a molecular weight distribution (Mw/Mn), as determined by gel permeation chromatography (GPC), in the range from 2.00 to 5.00.

In a second aspect, the present invention is directed to a process for obtaining the monophasic propylene-ethylene random copolymer composition (R-PP according to the first aspect, comprising the steps of:
a) polymerizing propylene and ethylene comonomer units in a first polymerization reactor in the presence of a single-site catalyst to produce a first polymerization mixture comprising a first propylene-ethylene random copolymer fraction (R-PP1) and the single-site catalyst, wherein the first polymerization reactor is preferably a slurry reactor, more preferably a loop reactor;
b) withdrawing said first polymerization mixture from the first polymerization reactor and optionally carrying out steps c1) through c3) prior to step d)
c1) transferring the first polymerization mixture into a second polymerization reactor, preferably a gas phase reactor;
c2) polymerizing propylene and ethylene comonomer units in said second polymerization reactor in the presence of said single-site catalyst to produce a second polymerization mixture comprising the first propylene-ethylene random copolymer fraction (R-PP1), the second propylene-ethylene random copolymer fraction (R-PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, optionally with the addition of additives (A).

In a final aspect, the present invention is directed to an article comprising the monophasic propylene-ethylene random copolymer composition (R-PP) of the first aspect in an amount of at least 75 wt.-%.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

In the following amounts are given in % by weight (wt.-%) unless it is stated otherwise.

A propylene homopolymer is a polymer that essentially consists of propylene monomer units. Due to impurities especially during commercial polymerization processes, a propylene homopolymer can comprise up to 0.1 mol-% comonomer units, preferably up to 0.05 mol-% comonomer units and most preferably up to 0.01 mol-% comonomer units.

A propylene random copolymer is a copolymer of propylene monomer units and comonomer units, preferably selected from ethylene and C₄-C₈ alpha-olefins, in which the comonomer units are distributed randomly over the polymeric chain. The propylene random copolymer can comprise comonomer units from one or more comonomers different in their amounts of carbon atoms.

In the context of the present invention, the term “propylene-ethylene random copolymer” means that no further comonomers beyond propylene and ethylene are present in the copolymer. Terpolymers, such as propylene-ethylene-1-hexene terpolymers are thus not included in this definition.

Typical for monophasic propylene homopolymers and monophasic propylene random copolymers is the presence of only one glass transition temperature. There is an absence of disperse particles of a elastomeric second phase, which would have a second glass transition temperature.

Bimodal polymers are polymers having a bimodal distribution of one or more properties. Bimodal random propylene-ethylene copolymers may typically be bimodal with respect to ethylene content or bimodal with respect to molecular weight (as seen through the melt flow rates of the first fraction and the final composition).

### DETAILED DESCRIPTION

### The Monophasic Propylene-Ethylene Random Copolymer Composition (R-PP)

The monophasic propylene-ethylene random copolymer composition (R-PP) has a melt flow rate (MFR₂), determined according to ISO 1133 at 230° C. at a load of 2.16 kg, in the range from 0.01 to 1.00 g/10 min, more preferably in the range from 0.05 to 0.70 g/10 min, most preferably in the range from 0.10 to 0.40 g/10 min. It is also preferred that the monophasic propylene-ethylene random copolymer composition (R-PP) has a melt flow rate (MFR₂), determined according to ISO 1133 at 230° C. at a load of 2.16 kg, in the range from 0.01 to 0.70 g/10 min, more preferably in the range from 0.01 to 0.40 g/10 min.

The monophasic propylene-ethylene random copolymer composition (R-PP) has an ethylene content (C2), as determined by ¹³C-NMR spectroscopy, in the range from 1.5 to 7.5 mol-%, more preferably in the range from 2.5 to 6.5 mol-%, most preferably in the range from 3.5 to 5.5 mol-%.

The monophasic propylene-ethylene random copolymer composition (R-PP) has a melting temperature (Tm), determined according to DSC analysis, in the range from 120 to 150° C., more preferably in the range from 122 to 145° C., most preferably in the range from 125 to 140° C.

The monophasic propylene-ethylene random copolymer composition (R-PP) has a molecular weight distribution (Mw/Mn), as determined by gel permeation chromatography (GPC), in the range from 2.00 to 5.00, more preferably in the range from 2.40 to 4.80, most preferably in the range from 2.50 to 4.70. It is particularly preferred that the monophasic propylene-ethylene random copolymer composition (R-PP) has a molecular weight distribution (Mw/Mn), as determined by gel permeation chromatography (GPC), in the range from 2.90 to 5.00, more preferably in the range from 2.90 to 4.80, most preferably in the range from 2.90 to 4.70.

The monophasic propylene-ethylene random copolymer composition (R-PP) preferably has a xylene cold soluble content (XCS), as determined according to ISO 16152, in the range from 0.10 to 5.0 wt.-%, more preferably in the range from 0.20 to 3.0 wt.-%, most preferably in the range from 0.30 to 1.0 wt.-%. It is particularly preferred that the monophasic propylene-ethylene random copolymer composition (R-PP) preferably has a xylene cold soluble content (XCS), as determined according to ISO 16152, in the range from 0.10 to 1.0 wt.-%, more preferably in the range from 0.20 to 1.0 wt.-%, most preferably in the range from 0.30 to 1.0 wt.-%.

The monophasic propylene-ethylene random copolymer composition (R-PP) preferably has a crystallization temperature (Tc), determined according to DSC analysis, in the range from 80 to 110° C., more preferably in the range from 85 to 105° C., most preferably in the range from 90 to 100° C.

As stated above, the term “propylene-ethylene random copolymer” means that no further comonomers may be present. Thus, the monophasic propylene-ethylene random copolymer composition (R-PP) consists essentially of monomer units derived from propylene and ethylene.

The term “2,1 regiodefects” as used in the present invention defines the sum of 2,1 erythro regiodefects and 2,1 threo regiodefects

The presence of 2,1-regiodefects in the monophasic propylene-ethylene random copolymer composition (R-PP) is indicative that the monophasic propylene-ethylene random copolymer composition (R-PP) has been polymerized in the presence of a single site catalyst (SSC).

It is therefore also preferred that the monophasic propylene-ethylene random copolymer composition (R-PP) has been polymerized in the presence of a single site catalyst (SSC), more preferably a metallocene catalyst.

The monophasic propylene-ethylene random copolymer composition (R-PP) has a content of 2,1-regiodefects, as determined by quantitative ¹³C-NMR spectroscopy analysis, in the range from 0.05 to 1.20 mol-%, more preferably in the range from 0.10 to 1.00 mol-%, most preferably in the range from 0.15 to 0.90 mol-%.

The content of 2,1-regiodefects may be dependent on the amount of comonomer, with higher amounts of comonomers often associated with lower content of 2,1-regiodefects.

The content of 2,1-regiodefects may also be dependent on the polymerization temperature, with higher temperatures often associated with lower content of 2,1-regiodefects.

As the monophasic propylene-ethylene random copolymer composition (R-PP) is not a heterophasic system comprising an elastomeric rubber layer, the monophasic propylene-ethylene random copolymer composition (R-PP) preferably does not have a glass transition temperature below −30° C., more preferably does not have a glass transition temperature below −25° C., most preferably does not have a glass transition temperature below −20° C.

The monophasic propylene-ethylene random copolymer composition (R-PP) preferably has a flexural modulus, determined according to ISO 178 using 80×10×4 mm³ test bars injection moulded in line with ISO 19069-2, in the range from 500 to 1500 MPa, more preferably in the range from 700 to 1200 MPa, most preferably in the range from 800 to 1000 MPa.

The monophasic propylene-ethylene random copolymer composition (R-PP) preferably has a Charpy notched impact strength (NIS), determined at +23° C. according to ISO 179/leA using 80×10×4 mm³ test bars injection moulded in line with ISO 19069-2, in the range from 5.0 to 20.0 KJ/m², more preferably in the range from 7.0 to 15.0 KJ/m², most preferably in the range from 8.0 to 12.0 KJ/m². It is particularly preferred that the monophasic propylene-ethylene random copolymer composition (R-PP) preferably has a Charpy notched impact strength (NIS), determined at +23° C. according to ISO 179/leA using 80×10×4 mm³ test bars injection moulded in line with ISO 19069-2, in the range from 7.0 to 20.0 KJ/m², more preferably in the range from 8.0 to 20.0 kJ/m².

In one particular embodiment, the monophasic propylene-ethylene random copolymer composition (R-PP) is a unimodal propylene-ethylene random copolymer. This means that the monophasic propylene-ethylene random copolymer composition (R-PP) is unimodal with respect to all measurable properties, including molecular weight and ethylene content.

The monophasic propylene-ethylene random copolymer composition (R-PP) being unimodal does not exclude the presence of additives known in the art; however, this remaining part shall be not more than 5.0 wt.-%, preferably not more than 3.0 wt.-%, like not more than 2.0 wt.-% within the monophasic propylene-ethylene random copolymer composition (R-PP). For instance, the monophasic propylene-ethylene random copolymer composition (R-PP) may comprise additionally small amounts of additives (A) selected from the group consisting of antioxidants, stabilizers, fillers, colorants, nucleating agents and antistatic agents. In general, they may be incorporated during the compounding of the monophasic propylene-ethylene random copolymer composition (R-PP).

In one particular embodiment, the monophasic propylene-ethylene random copolymer composition (R-PP) is a bimodal propylene-ethylene random copolymer.

In said embodiment, the monophasic propylene-ethylene random copolymer composition (R-PP) comprises 40 to 70 wt.-%, relative to the total weight of the monophasic propylene-ethylene random copolymer composition (R-PP), of a first propylene-ethylene random copolymer fraction (R-PP1) and 30 to 60 wt.-%, relative to the total weight of the monophasic propylene-ethylene random copolymer composition (R-PP), of a second propylene-ethylene random copolymer fraction (R-PP2).

More preferably, the monophasic propylene-ethylene random copolymer composition (R-PP) comprises 45 to 65 wt.-%, relative to the total weight of the monophasic propylene-ethylene random copolymer composition (R-PP), of a first propylene-ethylene random copolymer fraction (R-PP1) and 35 to 55 wt.-%, relative to the total weight of the monophasic propylene-ethylene random copolymer composition (R-PP), of a second propylene-ethylene random copolymer fraction (R-PP2).

It is particularly preferred that the monophasic propylene-ethylene random copolymer composition (R-PP) comprises 50 to 63 wt.-%, relative to the total weight of the monophasic propylene-ethylene random copolymer composition (R-PP), of a first propylene-ethylene random copolymer fraction (R-PP1) and 37 to 50 wt.-%, relative to the total weight of the monophasic propylene-ethylene random copolymer composition (R-PP), of a second propylene-ethylene random copolymer fraction (R-PP2).

The first propylene-ethylene random copolymer fraction (R-PP1) and the second propylene-ethylene random copolymer fraction (R-PP2) combined make up at least 95 wt.-% of the total weight of the monophasic propylene-ethylene random copolymer composition (R-PP), more preferably at least 97 wt.-%, most preferably at least 98 wt.-%.

In addition to the first propylene-ethylene random copolymer fraction (R-PP1) and the second propylene-ethylene random copolymer fraction (R-PP2), the monophasic propylene-ethylene random copolymer composition (R-PP) may comprise further additives known in the art; however, this remaining part shall be not more than 5.0 wt.-%, preferably not more than 3.0 wt.-%, like not more than 2.0 wt.-% within the monophasic propylene-ethylene random copolymer composition (R-PP). For instance, the monophasic propylene-ethylene random copolymer composition (R-PP) may comprise additionally small amounts of additives (A) selected from the group consisting of antioxidants, stabilizers, fillers, colorants, nucleating agents and antistatic agents. In general, they may be incorporated during the compounding of the monophasic propylene-ethylene random copolymer composition (R-PP).

In one particular embodiment, the monophasic propylene-ethylene random copolymer composition (R-PP) consists of the first propylene-ethylene random copolymer fraction (R-PP1), the second propylene-ethylene random copolymer fraction (R-PP2), and optionally additives (A).

In case the monophasic propylene-ethylene random copolymer composition (R-PP) of either the unimodal or bimodal embodiments comprises an α-nucleating agent, it is preferred that it is free of β-nucleating agents. The α-nucleating agent is preferably selected from the group consisting of
(i) salts of monocarboxylic acids and polycarboxylic acids, e.g. sodium benzoate or aluminum tert-butylbenzoate, and
(ii) dibenzylidenesorbitol (e.g. 1,3:2,4 dibenzylidenesorbitol) and C₁-C₈-alkyl-substituted dibenzylidenesorbitol derivatives, such as methyldibenzylidenesorbitol, ethyldibenzylidenesorbitol or dimethyldibenzylidenesorbitol (e.g. 1,3:2,4 di(methylbenzylidene) sorbitol), or substituted nonitol-derivatives, such as 1,2,3,-trideoxy-4,6:5,7-bis-O-[(4-propylphenyl)methylene]-nonitol, and
(iii) salts of diesters of phosphoric acid, e.g. sodium 2,2′-methylenebis(4,6,-di-tert-butylphenyl) phosphate or aluminium-hydroxy-bis[2,2′-methylene-bis(4,6-di-t-butylphenyl)phosphate], and
(iv) vinylcycloalkane polymer and vinylalkane polymer (as discussed in more detail below), and
(v) mixtures thereof.

Such additives are generally commercially available and are described, for example, in “Plastic Additives Handbook”, pages 871 to 873, 5th edition, 2001 of Hans Zweifel.

It is understood that the content of additives (A), given with respect to the total weight of the monophasic propylene-ethylene random copolymer composition (R-PP), includes any carrier polymers used to introduce the additives to said monophasic propylene-ethylene random copolymer composition (R-PP), i.e. masterbatch carrier polymers. An example of such a carrier polymer would be a polypropylene homopolymer in the form of powder.

### First Propylene-Ethylene Random Copolymer Fraction (R-PP1)

The first propylene-ethylene random copolymer fraction (R-PP1) is a copolymer of propylene and ethylene.

The first propylene-ethylene random copolymer fraction (R-PP1) preferably has an ethylene content (C2), as determined by ¹³C-NMR spectroscopy, in the range from 0.6 to 4.5 mol-%, more preferably in the range from 0.8 to 3.6 mol-%, most preferably in the range from 1.0 to 3.0 mol-%.

The first propylene-ethylene random copolymer fraction (R-PP1) preferably has a melt flow rate (MFR₂), determined according to ISO 1133 at 230° C. at a load of 2.16 kg, in the range from 0.01 to 4.0 g/10 min, more preferably in the range from 0.1 to 2.0 g/10 min, most preferably in the range from 0.2 to 1.0 g/10 min.

The monophasic propylene-ethylene random copolymer composition (R-PP) may be bimodal with respect to molecular weight (as indicated by melt flow rate values). As such, it is preferred that the ratio of the melt flow rate (MFR₂) of the monophasic propylene-ethylene random copolymer composition (R-PP) to the melt flow rate (MFR₂) of the first propylene-ethylene random copolymer fraction (R-PP1), both determined according to ISO 1133 at 230° C. at a load of 2.16 kg and expressed in g/10 min, ([MFR(R-PP)]/[MFR(R-PP1)]) in the range from 0.20 to 1.00, more preferably in the range from 0.25 to 0.75, most preferably in the range from 0.33 to 0.50.

Additionally or alternatively, the monophasic propylene-ethylene random copolymer composition (R-PP) may be bimodal with respect to ethylene content. As such, the ratio of the ethylene content of the monophasic propylene-ethylene random copolymer composition (R-PP) to the ethylene content of the first propylene-ethylene random copolymer fraction (R-PP1), both determined by quantitative ¹³C-NMR spectroscopy and expressed in mol-%, ([C2 (R-PP)]/[C2 (R-PP1)]) is in the range from 1.00 to 3.00, more preferably in the range from 1.10 to 2.50, most preferably in the range from 1.20 to 2.00.

### Second Propylene-Ethylene Random Copolymer Fraction (R-PP2)

The second propylene-ethylene random copolymer fraction (R-PP2) is a copolymer of propylene and ethylene.

The second propylene-ethylene random copolymer fraction (R-PP2) preferably has an ethylene content (C2), as determined by ¹³C-NMR spectroscopy, in the range from 0.9 to 9.0 mol-%, more preferably in the range from 1.5 to 8.0 mol-%, most preferably in the range from 3.0 to 7.0 mol-%.

The second propylene-ethylene random copolymer fraction (R-PP2) preferably has a melt flow rate (MFR₂), determined according to ISO 1133 at 230° C. at a load of 2.16 kg, in the range from 0.01 to 1.00 g/10 min, more preferably in the range from 0.02 to 0.50 g/10 min, most preferably in the range from 0.03 to 0.30 g/10 min.

### The Process

In a second aspect, the present invention is directed to a process for obtaining the monophasic propylene-ethylene random copolymer composition (R-PP) according to the first aspect, comprising the steps of:
a) polymerizing propylene and ethylene comonomer units in a first polymerization reactor in the presence of a single-site catalyst to produce a first polymerization mixture comprising a first propylene-ethylene random copolymer fraction (R-PP1) and the single-site catalyst, wherein the first polymerization reactor is preferably a slurry reactor, more preferably a loop reactor;
b) withdrawing said first polymerization mixture from the first polymerization reactor and optionally carrying out steps c1) through c3) prior to step d)
c1) transferring the first polymerization mixture into a second polymerization reactor, preferably a gas phase reactor;
c2) polymerizing propylene and ethylene comonomer units in said second polymerization reactor in the presence of said single-site catalyst to produce a second polymerization mixture comprising the first propylene-ethylene random copolymer fraction (R-PP1), the second propylene-ethylene random copolymer fraction (R-PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, optionally with the addition of additives (A).

If the monophasic propylene-ethylene random copolymer composition (R-PP) is a unimodal monophasic propylene-ethylene random copolymer composition, then steps c1) to c3) are absent, meaning that the process comprises the steps of:
a) polymerizing propylene and ethylene comonomer units in a first polymerization reactor in the presence of a single-site catalyst to produce a first polymerization mixture comprising a first propylene-ethylene random copolymer fraction (R-PP1) and the single-site catalyst, wherein the first polymerization reactor is preferably a slurry reactor, more preferably a loop reactor;
b) withdrawing said first polymerization mixture from the first polymerization reactor; and
d) compounding the first polymerization mixture, optionally with the addition of additives (A).

If the monophasic propylene-ethylene random copolymer composition (R-PP) is a bimodal monophasic propylene-ethylene random copolymer composition, then steps c1) to c3) are present, meaning that the process comprises the steps of:
a) polymerizing propylene and ethylene comonomer units in a first polymerization reactor in the presence of a single-site catalyst to produce a first polymerization mixture comprising a first propylene-ethylene random copolymer fraction (R-PP1) and the single-site catalyst, wherein the first polymerization reactor is preferably a slurry reactor, more preferably a loop reactor;
b) withdrawing said first polymerization mixture from the first polymerization reactor;
c1) transferring the first polymerization mixture into a second polymerization reactor, preferably a gas phase reactor;
c2) polymerizing propylene and ethylene comonomer units in said second polymerization reactor in the presence of said single-site catalyst to produce a second polymerization mixture comprising the first propylene-ethylene random copolymer fraction (R-PP1), the second propylene-ethylene random copolymer fraction (R-PP2) and the single-site catalyst;
c3) withdrawing said second polymerization mixture from said second polymerization reactor; and
d) compounding the second polymerization mixture, optionally with the addition of additives (A).

It is preferred that the operating temperature in the first polymerization reactor (R1) is in the range from 60 to 85° C., more preferably in the range from 62 to 80° C., still more preferably in the range from 65 to 75° C.

Alternatively or additionally to the previous paragraph it is preferred that the operating temperature in the second polymerization reactor (R2), if such a reactor is present, is in the range from 70 to 95° C., more preferably in the range from 73 to 85° C.

Typically, the pressure in the first polymerization reactor (R1), preferably in the loop reactor (LR), is in the range from 20 to 80 bar, preferably 30 to 70 bar, like 35 to 65 bar, whereas the pressure in the second polymerization reactor (R2), i.e. in the gas phase reactor (GPR), is in the range from 5 to 50 bar, preferably 15 to 40 bar.

Preferably hydrogen is added in each polymerization reactor in order to control the molecular weight, i.e. the melt flow rate MFR₂.

The preparation of the propylene-ethylene random copolymer can comprise in addition to the (main) polymerization of the propylene-ethylene random copolymer in the polymerization reactors (R1 and optionally R2) prior thereto a pre-polymerization in a pre-polymerization reactor (PR) upstream to the first polymerization reactor (R1).

In the pre-polymerization reactor (PR) a polypropylene (Pre-PP) is produced. The pre-polymerization is conducted in the presence of the single site catalyst (SSC). According to this embodiment, the single site catalyst is introduced to the pre-polymerization step. However, this shall not exclude the option that at a later stage for instance further co-catalyst is added in the polymerization process, for instance in the first reactor (R1). In one embodiment, all components of the single site catalyst are only added in the pre-polymerization reactor (PR), if a pre-polymerization is applied.

The pre-polymerization reaction is typically conducted at a temperature of 0 to 60° C., preferably from 15 to 50° C., and more preferably from 18 to 45° C.

The pressure in the pre-polymerization reactor is not critical but must be sufficiently high to maintain the reaction mixture in liquid phase. Thus, the pressure may be from 20 to 100 bar, for example 30 to 70 bar.

In a preferred embodiment, the pre-polymerization is conducted as bulk slurry polymerization in liquid propylene, i.e. the liquid phase mainly comprises propylene, with optionally inert components dissolved therein. Furthermore, according to the present invention, an ethylene feed is employed during pre-polymerization as mentioned above.

It is possible to add other components also to the pre-polymerization stage. Thus, hydrogen may be added into the pre-polymerization stage to control the molecular weight of the polypropylene (Pre-PP) as is known in the art. Further, antistatic additive may be used to prevent the particles from adhering to each other or to the walls of the reactor.

The precise control of the pre-polymerization conditions and reaction parameters is within the skill of the art.

Due to the above defined process conditions in the pre-polymerization, preferably a mixture (MI) of the single site catalyst (SSC) and the polypropylene (Pre-PP) produced in the pre-polymerization reactor (PR) is obtained. Preferably, the single site catalyst (SSC) is (finely) dispersed in the polypropylene (Pre-PP). In other words, the single site catalyst (SSC) particles introduced in the pre-polymerization reactor (PR) are split into smaller fragments that are evenly distributed within the growing polypropylene (Pre-PP). The sizes of the introduced single site catalyst (SSC) particles as well as of the obtained fragments are not of essential relevance for the instant invention and within the skilled knowledge.

As mentioned above, if a pre-polymerization is used, subsequent to said pre-polymerization, the mixture (MI) of the single site catalyst (SSC) and the polypropylene (Pre-PP) produced in the pre-polymerization reactor (PR) is transferred to the first reactor (R1). Typically the total amount of the polypropylene (Pre-PP) in the final bimodal propylene-ethylene copolymer (R-PP) is rather low and typically not more than 5.0 wt.-%, more preferably not more than 4.0 wt.-%, still more preferably in the range from 0.5 to 4.0 wt.-%, like in the range 1.0 of to 3.0 wt.-%.

In case that pre-polymerization is not used, propylene and the other ingredients such as the single site catalyst (SSC) are directly introduced into the first polymerization reactor (R1).

In one embodiment, the present invention is directed to a monophasic propylene-ethylene random copolymer composition (R-PP) as described above that is obtainable, more preferably obtained, through the process as described herein. All preferable embodiments and fall-back positions given for the monophasic propylene-ethylene random copolymer composition (R-PP) above and below apply mutatis mutandis to the monophasic propylene-ethylene random copolymer composition (R-PP) obtainable/obtained through the present process.

### Catalyst System

The single site catalyst according to the present invention may be any supported metallocene catalyst suitable for the production of isotactic polypropylene.

It is preferred that the single site catalyst (SSC) comprises a metallocene complex, a co-catalyst system comprising a boron containing co-catalyst and/or an aluminoxane co-catalyst, and a silica support.

In particular, it is preferred that the single site catalyst (SSC) comprises
(i) a metallocene complex of the general formula (I)

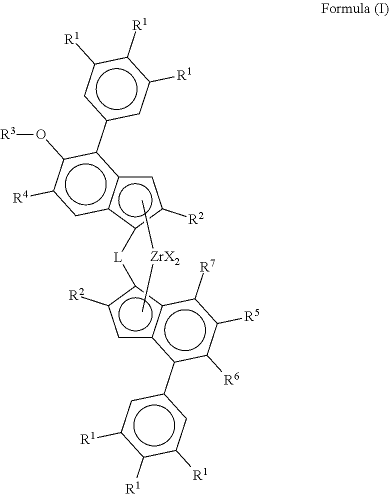

wherein each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a co-catalyst system comprising a boron containing co-catalyst and/or an aluminoxane co-catalyst, and
(iii) a silica support.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′₃, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16. In a preferred embodiment the anionic ligands “X” are identical and either halogen, like Cl, or methyl or benzyl.

A preferred monovalent anionic ligand is halogen, in particular chlorine (Cl).

More preferably, the metallocene catalyst has the formula (Ia)

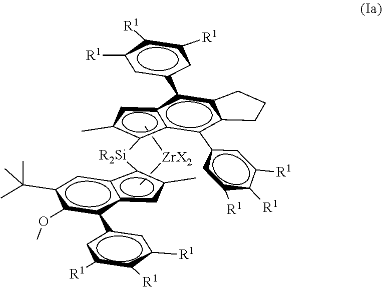

wherein each R′ are independently the same or can be different and are hydrogen or a linear or branched C₁-C₆ alkyl group, whereby at least one R¹ per phenyl group is not hydrogen, R′ is a C₁-C₁₀ hydrocarbyl group, preferably a C₁-C₄ hydrocarbyl group and more preferably a methyl group and
X independently is a hydrogen atom, a halogen atom, C₁-C₆ alkoxy group, C₁-C₆ alkyl group, phenyl or benzyl group.

Most preferably, X is chlorine, benzyl or a methyl group. Preferably, both X groups are the same. The most preferred options are two chlorides, two methyl or two benzyl groups, especially two chlorides.

Preferred complexes of the metallocene catalyst include:
rac-dimethylsilanediylbis[2-methyl-4-(3′,5′-dimethylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl] zirconium dichloride, rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

Especially preferred is rac-anti-dimethylsilanediyl[2-methyl-4,8-bis-(3′,5′-dimethylphenyl)-1,5,6,7-tetrahydro-sindacen-1-yl][2-methyl-4-(3′,5′-dimethylphenyl)-5-methoxy-6-tert-butylinden-1-yl] zirconium dichloride.

The ligands required to form the complexes and hence catalysts of the invention can be synthesised by any process and the skilled organic chemist would be able to devise various synthetic protocols for the manufacture of the necessary ligand materials. For Example WO2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959, in which the most preferred catalyst of the present invention is described.

### Co-Catalyst

To form an active catalytic species it is normally necessary to employ a co-catalyst as is well known in the art.

According to the present invention an aluminoxane co-catalyst may be used in combination with the above defined metallocene catalyst complex.

The aluminoxane co-catalyst can be one of formula (II):

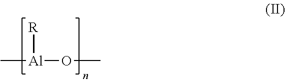

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (II).

The preferred aluminoxane is methylaluminoxane (MAO). Since the aluminoxanes used as co-catalysts according to the invention are not, owing to their mode of preparation, pure compounds, the molarity of aluminoxane solutions hereinafter is based on their aluminium content.

According to the present invention, also a boron containing co-catalyst can be used instead of the aluminoxane co-catalyst or the aluminoxane co-catalyst can be used in combination with a boron containing co-catalyst.

It will be appreciated by the person skilled in the art that where boron based co-catalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate co-catalyst is used, the metallocene catalyst complex is in its alkylated version, that is for example a dimethyl or dibenzyl metallocene catalyst complex can be used.

Boron based co-catalysts of interest include those of formula (III)

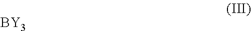

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris(3,4,5-trifluorophenyl)borane.

Particular preference is given to tris(pentafluorophenyl)borane.

However it is preferred that borates are used, i.e. compounds containing a borate 3+ ion.

Such ionic co-catalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
triethylammoniumtetra(phenyl)borate,
tributylammoniumtetra(phenyl)borate,
trimethylammoniumtetra(tolyl)borate,
tributylammoniumtetra(tolyl)borate,
tributylammoniumtetra(pentafluorophenyl)borate,
tripropylammoniumtetra(dimethylphenyl borate,
tributylammoniumtetra(trifluoromethylphenyl)borate,
tributylammoniumtetra(4-fluorophenyl)borate,
N,N-dimethylcyclohexylammoniumtetrakis(pentafluorophenyl)borate,
N,N-dimethylbenzylammoniumtetrakis(pentafluorophenyl)borate,
N,N-dimethylaniliniumtetra(phenyl)borate,
N,N-diethylaniliniumtetra(phenyl)borate,
N,N-dimethylaniliniumtetrakis(pentafluorophenyl)borate,
N,N-di(propyl)ammoniumtetrakis(pentafluorophenyl)borate,
di(cyclohexyl)ammoniumtetrakist(pentafluorophenyl)borate,
triphenylphosphoniumtetrakis(phenyl)borate,
triethylphosphoniumtetrakis(phenyl)borate,
diphenylphosphoniumtetrakis(phenyl)borate,
tri(methylphenyl)phosphoniumtetrakis(phenyl)borate,
tri(dimethylphenyl)phosphoniumtetrakis(phenyl)borate,
triphenylcarbeniumtetrakis(pentafluorophenyl)borate,
or ferroceniumtetrakis(pentafluorophenyl)borate.

Preference is given to triphenylcarbeniumtetrakis(pentafluorophenyl)borate, N,N-dimethylcyclohexylammoniumtetrakis(pentafluorophenyl)borate or N,N-dimethylbenzylammoniumtetrakis(pentafluorophenyl)borate.

It has been surprisingly found that certain boron co-catalysts are especially preferred. Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

According to the present invention, the preferred co-catalysts are aluminoxanes, more preferably methylaluminoxanes, combinations of aluminoxanes with Al-alkyls, boron or borate co-catalysts, and combination of aluminoxanes with boron-based co-catalysts.

Suitable amounts of co-catalyst will be well known to the person skilled in the art.

The molar ratio of boron to the metal ion of the metallocene may be in the range 0.5:1 to 10:1 mol/mol, preferably 1:1 to 10:1, especially 1:1 to 5:1 mol/mol.

The molar ratio of Al in the aluminoxane to the metal ion of the metallocene may be in the range 1:1 to 2000:1 mol/mol, preferably 10:1 to 1000:1, and more preferably 50:1 to 500:1 mol/mol.

The catalyst can be used in supported or unsupported form, preferably in supported form. The particulate support material used is preferably an organic or inorganic material, such as silica, alumina or zirconia or a mixed oxide such as silica-alumina, in particular silica, alumina or silica-alumina. The use of a silica support is preferred. The person skilled in the art is aware of the procedures required to support a metallocene catalyst.

Especially preferably, the support is a porous material so that the complex may be loaded into the pores of the support, e.g. using a process analogous to those described in WO94/14856 (Mobil), WO95/12622 (Borealis) and WO2006/097497.

The average particle size of the silica support can be typically from 10 to 100 μm. However, it has turned out that special advantages can be obtained if the support has a median particle size d50 from 15 to 80 μm, preferably from 18 to 50 μm.

The average pore size of the silica support can be in the range 10 to 100 nm and the pore volume from 1 to 3 mL/g.

Examples of suitable support materials are, for instance, ES757 produced and marketed by PQ Corporation, Sylopol 948 produced and marketed by Grace or SUNSPERA DM-L-303 silica produced by AGC Si-Tech Co. Supports can be optionally calcined prior to the use in catalyst preparation in order to reach optimal silanol group content.

The use of these supports is routine in the art.

In a particularly preferred embodiment, the catalyst system corresponds to either ICS3 or CCS4 of WO 2020/239602 A1.

### The Article

In a final aspect, the present invention is directed to an article comprising the monophasic propylene-ethylene random copolymer composition (R-PP) in an amount of at least 75 wt.-%, more preferably at least 90 wt.-%, most preferably at least 95 wt.-%.

In one particular embodiment, the article consists of the monophasic propylene-ethylene random copolymer composition (R-PP).

It is particularly preferred that the article is a pipe.

The pipe preferably has a pipe pressure test stability (20° C., 16 MPa) following ISO 1167-1 and -2 of at least 20 h, more preferably of at least 30 h, most preferably of at least 40 h.

Additionally or alternatively, the pipe preferably has a pipe pressure test stability (95° C., 4.6 MPa) following ISO 1167-1 and -2 of at least 200 h, more preferably of at least 1000 h, most preferably of at least 5000 h.

### Examples

### A. Measuring Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the isotacticity and regio-regularity of the polymers.

Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics.

For polymers approximately 200 mg of material was dissolved in 1,2-tetrachloroethane-d₂ (TCE-d₂). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution needed for tacticity distribution quantification (Busico, V., Cipullo, R., Prog. Polym. Sci. 26 (2001) 443; Busico, V.; Cipullo, R., Monaco, G., Vacatello, M., Segre, A. L., Macromolecules 30 (1997) 6251). Standard single-pulse excitation was employed utilising the NOE and bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 11289). A total of 8192 (8 k) transients were acquired per spectra. Quantitative ¹³C{¹H} NMR spectra were processed, integrated and relevant quantitative properties determined from the integrals using proprietary computer programs. For propylene homopolymers all chemical shifts are internally referenced to the methyl isotactic pentad (mmmm) at 21.85 ppm.

Characteristic signals corresponding to regio defects (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) or comonomer were observed.

The tacticity distribution was quantified through integration of the methyl region between 23.6-19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromolecules 30 (1997) 6251).

Specifically the influence of regio-defects and comonomer on the quantification of the tacticity distribution was corrected for by subtraction of representative regio-defect and comonomer integrals from the specific integral regions of the stereo sequences.

The isotacticity was determined at the pentad level and reported as the percentage of isotactic pentad (mmmm) sequences with respect to all pentad sequences:

$$[ mmmm ] \% = 100 * ( mmmm / sum of all pentads )$$

The presence of 2,1 erythro regio-defects was indicated by the presence of the two methyl sites at 17.7 and 17.2 ppm and confirmed by other characteristic sites. Characteristic signals corresponding to other types of regio-defects were not observed (Resconi, L., Cavallo, L., Fait, A., Piemontesi, F., Chem. Rev. 2000, 100, 1253).

The amount of 2,1 erythro regio-defects was quantified using the average integral of the two characteristic methyl sites at 17.7 and 17.2 ppm:

$${P}_{21 e} = ( {I}_{e 6} + {I}_{e 8} ) / 2$$

The amount of 1,2 primary inserted propylene was quantified based on the methyl region with correction undertaken for sites included in this region not related to primary insertion and for primary insertion sites excluded from this region:

$${P}_{12} = {I}_{C H 3} + {P}_{12 e}$$

The total amount of propylene was quantified as the sum of primary inserted propylene and all other present regio-defects:

$${P}_{total} = {P}_{12} + {P}_{21 e}$$

The mole percent of 2,1 erythro regio-defects was quantified with respect to all propylene:

$$[ 21 e ] mol - \% = 100 * ( {P}_{21 e} / {P}_{t otal} )$$

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( S αβ + S αγ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol - \% ] = 100 * fE$$

The weight percent comonomer incorporation was calculated from the mole fraction:

$$E [ wt . - \% ] = 100 * ( fE * 28.06 ) / ( ( fE * 28.06 ) + ( ( 1 - fE ) * 42.08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

The relative content of isolated to block ethylene incorporation was calculated from the triad sequence distribution using the following relationship (equation (I)):

$$I ( E ) = \frac{f P E P}{( fEEE + f P E E + f P E P )} \times 100 \qquad ( I )$$

wherein
I(E) is the relative content of isolated to block ethylene sequences [in %];
fPEP is the mol fraction of propylene/ethylene/propylene sequences (PEP) in the sample;
fPEE is the mol fraction of propylene/ethylene/ethylene sequences (PEE) and of ethylene/ethylene/propylene sequences (EEP) in the sample;
fEEE is the mol fraction of ethylene/ethylene/ethylene sequences (EEE) in the sample

Calculation of comonomer content of the second propylene-ethylene random copolymer fraction (R-PP2):

$$\frac{C ( P P ) - w ( PP 1 ) \times C ( PP 1 )}{w ( PP 2 )} = C ( PP 2 ) \qquad ( I )$$

wherein
w(PP1) is the weight fraction [in wt.-%] of the first propylene-ethylene random copolymer fraction (R-PP1),
w(PP2) is the weight fraction [in wt.-%] of second propylene-ethylene random copolymer fraction (R-PP2),
C(PP1) is the comonomer content [in mol-%] of the first propylene-ethylene random copolymer fraction (R-PP1),
C(PP) is the comonomer content [in mol-%] of the monophasic propylene-ethylene random copolymer composition (R-PP),
C(PP2) is the calculated comonomer content [in mol-%] of the second propylene-ethylene random copolymer fraction (R-PP2).

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR₂ of polypropylene was determined at a temperature of 230° C. and a load of 2.16 kg.

Calculation of melt flow rate MFR₂ (230° C.) of the second propylene-ethylene random copolymer fraction (PP2):

$$MFR ( PP 2 ) = {10}^{[ \frac{log ( MFR ( P P ) ) - w ( PP 1 ) \times log ( MFR ( PP 1 ) )}{w ( PP 2 )} ]} \qquad ( II )$$

wherein
w(PP1) is the weight fraction [in wt.-%] of the first propylene-ethylene random copolymer fraction (R-PP1),
w(PP2) is the weight fraction [in wt.-%] of second propylene-ethylene random copolymer fraction (R-PP2),
MFR(PP1) is the melt flow rate MFR₂ (230° C.) [in g/10 min] of the first propylene-ethylene random copolymer fraction (R-PP1),
MFR(PP) is the melt flow rate MFR₂ (230° C.) [in g/10 min] of the monophasic propylene-ethylene random copolymer composition (R-PP),
MFR(PP2) is the calculated melt flow rate MFR₂ (230° C.) [in g/10 min] of the second propylene-ethylene random copolymer fraction (R-PP2).

The xylene soluble fraction at room temperature (XCS, wt.-%): The amount of the polymer soluble in xylene was determined at 25° C. according to ISO 16152; 5^{th} edition; 2005 Jul. 1.

### Number Average Molecular Weight (Mn), Weight Average Molecular Weight (Mw), Size Average Molecular Weight, and Molecular Weight Distribution (MWD)

Molecular weight averages (Mz, Mw, Mn), and the molecular weight distribution (MWD), i.e. the Mz/Mw (wherein Mz is the size average molecular weight and Mw is the weight average molecular weight), were determined by Gel Permeation.

Chromatography (GPC) according to ISO 16014-4:2003 and ASTM D 6474-99. A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/L 2,6-Di tert butyl-4-methyl-phenol) as solvent at 160° C. and at a constant flow rate of 1 mL/min. 200 μl. of sample solution were injected per analysis. The column set was calibrated using universal calibration (according to ISO 16014-2:2003) with at least 15 narrow MWD polystyrene (PS) standards in the range from 0.5 kg/mol to 11 500 kg/mol. Mark Houwink constants for PS, PE and PP used are as described per ASTM D 6474-99. All samples were prepared by dissolving 5.0-9.0 mg of polymer in 8 mL (at 160° C.) of stabilized TCB (same as mobile phase) for 2.5 hours for PP or 3 hours for PE at max. 160° C. under continuous gentle shaking in the autosampler of the GPC instrument.

DSC analysis, melting temperature (Tₘ) and heat of fusion (H_{f}), crystallization temperature (T_{c}) and heat of crystallization (H_{c}): measured with a TA Instrument Q200 differential scanning calorimetry (DSC) on 5 to 7 mg samples. DSC was run according to ISO 11357/part 3/method C2 in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (H_{f}) were determined from the second heating step.

The glass transition temperature Tg was determined by dynamic mechanical analysis according to ISO 6721-7. The measurements were done in torsion mode on compression moulded samples (40×10×1 mm³) between −100° C. and +150° C. with a heating rate of 2° C./min and frequency of 1 Hz.

The Flexural Modulus was determined according to ISO 178 method A (3-point bending test) on 80 mm×10 mm×4 mm specimens. Following the standard, a test speed of 2 mm/min and a span length of 16 times the thickness was used. The testing temperature was 23±2° C. Injection moulding was carried out according to ISO 19069-2 using a melt temperature of 230° C. for all materials irrespective of material melt flow rate.

### Notched Impact Strength (NIS)

The Charpy notched impact strength (NIS) was measured according to ISO 179 leA at +23° C. or −20° C., using injection moulded bar test specimens of 80×10×4 mm³ prepared in accordance with ISO 19069-2 using a melt temperature of 230° C. for all materials irrespective of material melt flow rate.

### Pipe Pressure Test

The pressure test performance of pipes produced from the inventive and comparative compositions were tested in accordance with ISO 1167-1 and -2. The pipes having a diameter of 32 mm and a wall thickness of 3 mm were produced in accordance with ISO 1167-2 on a conventional pipe extrusion line, then subjected to a circumferential (hoop) stress of 16 MPa at a temperature of 20° C. (or a stress of 4.6 MPa at a temperature of 95° C.) in a water-in-water setup in accordance with ISO 1167-1. The time in hours to failure was registered, times with an additional “still running” meaning that the failure time had not yet been reached at the time of filing of the present patent application.

### B. Examples

The metallocene complex used in the polymerization process for the inventive examples was Anti-dimethylsilanediyl[2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl] zirconium dichloride as disclosed in WO 2019/179959 A1 as MC-2.

For inventive examples IE1 to IE3, the catalyst system was prepared analogously to Inventive Catalyst System 3 (ICS3) in WO 2020/239602 A1, whilst for inventive examples IE4 and IE5, the catalyst system was prepared analogously to Comparative Catalyst System 4 (CCS4) in WO 2020/239602 A1.

The catalyst used for CE2 was a transesterified Ziegler-Natta catalyst supported on magnesium chloride and prepared in accordance with the procedure of WO 92/19653, being identical to catalyst al) of WO 2012/171745 A1, whilst the catalyst used for CE3 was emulsion-type Ziegler-Natta catalyst, being identical to the catalyst used for the inventive examples in WO 2016/066446 A1.

The catalyst used for CE2 had a phthalate-based internal donor, whilst the catalyst used for CE3 had a citraconate-based internal donor. Both catalysts used di(cyclopentyl) dimethoxy silane (D-donor) as the external donor.

Inventive examples IE1 to IE5 and comparative examples CE2 and CE3 were polymerized according to the conditions given in Table 1 (note: The MFR₂ and C2 content given after reactor R2 are the properties of the GPR fraction (i.e. R-PP2) and were calculated from the values measured after the loop reactor (i.e. R-PP1) and in the final pellets (i.e. R-PP), using appropriate mixing rules, as given in the determination methods).

CE1 is the commercially available grade RA130E (available from Borcalis AG), which is a unimodal propylene-ethylene random copolymer produced using a Ziegler-Natta catalyst.

TABLE 1
Polymerization conditions for the inventive and comparative propylene-ethylene random copolymers

| | | | | | | |
|---|---|---|---|---|---|---|
| CE2 | CE3 | IE1 | IE2 | IE3 | IE4 | IE5 |

Prepolymerization (R0)

| | | | | | | | | |
|---|---|---|---|---|---|---|---|---|
| TEAL/Ti ratio | [mol/mol] | 90 | 90 | — | — | — | — | — |
| TEAL/donor ratio | [mol/mol] | 10 | 10 | — | — | — | — | — |
| Temperature | [° C.] | 20 | 25 | 18 | 20 | 20 | 20 | 20 |
| Pressure | [kPa] | 5300 | 5350 | 5000 | 5400 | 5400 | 5300 | 5350 |
| Residence time | [h] | 0.30 | 0.30 | 0.30 | 0.30 | 0.25 | 0.27 | 0.27 |

Loop (R1)

| | | | | | | | | |
|---|---|---|---|---|---|---|---|---|
| Temperature | [° C.] | 70 | 70 | 66 | 70 | 70 | 70 | 70 |
| Pressure | [kPa] | 5250 | 5400 | 4900 | 5400 | 5400 | 5400 | 5400 |
| H2/C3 ratio | [mol/kmol] | 0.12 | 0.01 | 0.10 | 0.05 | 0.07 | 0.06 | 0.07 |
| C2/C3 ratio | [mol/kmol] | 24.2 | 10.5 | 43.2 | 24.7 | 25.1 | 33.7 | 34.5 |
| split | [wt.-%] | 50 | 43 | 100 | 60 | 55 | 61 | 62 |
| MFR₂ | [g/10 min] | 0.04 | 0.07 | 0.32 | 0.49 | 0.80 | 0.37 | 0.38 |
| C2 content | [mol-%] | 6.3 | 5.4 | 5.0 | 1.5 | 2.1 | 3.3 | 3.1 |

GPR (R2)

| | | | | | | | | |
|---|---|---|---|---|---|---|---|---|
| Temperature | [° C.] | 68 | 70 | — | 75 | 75 | 75 | 75 |
| Pressure | [kPa] | 2400 | 2400 | — | 2500 | 2500 | 2500 | 2500 |
| H2/C3 ratio | [mol/kmol] | 66.4 | 9.93 | — | 0.37 | 0.37 | 0.37 | 0.50 |
| C2/C3 ratio | [mol/kmol] | 29.1 | 22.0 | — | 137 | 145 | 111 | 112 |
| split | [wt.-%] | 50 | 57 | — | 40 | 45 | 39 | 38 |
| MFR₂ | [g/10 min] | 0.72 | 0.37 | — | 0.21 | 0.09 | 0.04 | 0.05 |
| C2 content | [mol-%] | 4.9 | 5.7 | — | 6.6 | 6.0 | 5.5 | 5.0 |
| C2(R-PP)/C2(R-PP1) | — | 0.89 | 1.03 | — | 2.38 | 1.85 | 1.27 | 1.24 |
| MFR(R-PP)/MFR(R-PP1) | — | 4.25 | 2.57 | — | 0.71 | 0.38 | 0.43 | 0.45 |

TABLE 2
Properties of the inventive and comparative propylene-ethylene random copolymers

| | | | | | | | |
|---|---|---|---|---|---|---|---|
| CE1 | CE2 | CE3 | IE1 | IE2 | IE3 | IE4 | IE5 |

Composition

| | | | | | | | | | |
|---|---|---|---|---|---|---|---|---|---|
| MFR₂ | [g/10 min] | 0.27 | 0.17 | 0.18 | 0.32 | 0.35 | 0.30 | 0.16 | 0.17 |
| XCS | [wt.-%] | 8.3 | 7.0 | 8.8 | 0.73 | 0.35 | 0.54 | 0.47 | 0.97 |
| C2 content | [mol-%] | 6.5 | 5.6 | 5.6 | 5.0 | 3.6 | 3.8 | 4.1 | 3.8 |
| 2,1 regiodefects | [mol-%] | 0 | 0 | 0 | 0.55 | 0.60 | 0.58 | 0.66 | 0.65 |
| Mw/Mn | — | 6.8 | 7.1 | 8.2 | 2.9 | 4.5 | 3.9 | 4.0 | 4.1 |
| Tm | [° C.] | 143 | 144 | 144 | 128 | 137 | 136 | 131 | 131 |
| Tc | [° C.] | 102 | 102 | 102 | 92 | 98 | 97 | 93 | 93 |
| Flex Mod | [MPa] | 800 | 910 | 850 | 800 | 940 | 920 | 910 | 910 |
| NIS | [kJ/m²] | 20.0 | 15.5 | 14.2 | 9.8 | 12.5 | 17.8 | 19.1 | 18.2 |

As can be seen from Table 2, the inventive (SSC-catalysed) examples have comparative melt flow rates to those of the comparative (ZN-catalysed) examples, whilst the not dissimilar ethylene contents lead to drastically higher XCS content in the comparative examples (7 to 9 wt.-% versus less than 1 wt.-%). This lower extractable content means that the inventive compositions are much more suitable for use in pipe applications, in particular for conveying drinking water, since far less oligomer (and other extractables) will leach into the water.

Pipes having a diameter of 32 mm and a wall thickness of 3 mm were produced in accordance with ISO 1167-2, using compositions CE1, IE1 and IE5.

TABLE 3
Results of pipe pressure tests carried out using inventive
and comparative propylene-ethylene random copolymers

| | | CE1 | IE1 | IE5 |
|---|---|---|---|---|
| pipe pressure test | [h] | 9.8 | 47 | 758 |
| (20° C./16 MPa) | | | | |
| pipe pressure test | [h] | 6.0 | 5336 | 8201 |
| (95° C./4.6 MPa) | | | | |

As can be seen from Table 3 the inventive compositions have pipe pressure resistance values that vastly exceed those of the comparative Ziegler-Natta catalyzed composition. The bimodal example IE5 is yet further improved, having a notably superior performance relative to the unimodal example IE1.

1. A monophasic propylene-ethylene random copolymer composition (R-PP), having:
i) a melt flow rate (MFR₂), determined according to ISO 1133 at 230° C. at a load of 2.16 kg, in the range from 0.01 to 1.00 g/10 min;
ii) an ethylene content (C2), as determined by ¹³C-NMR spectroscopy, in the range from 1.5 to 7.5 mol-%;
iii) a melting temperature (Tm), determined according to DSC analysis, in the range from 120 to 150° C.;
iv) a content of 2,1-regiodefects, as determined by quantitative ¹³C-NMR spectroscopy analysis, in the range from 0.05 to 1.20 mol-%; and
v) a molecular weight distribution (Mw/Mn), as determined by gel permeation chromatography (GPC), in the range from 2.00 to 5.00.

2. The monophasic propylene-ethylene random copolymer composition (R-PP) according to claim 1, having a xylene cold soluble content (XCS), as determined according to ISO 16152, in the range from 0.10 to 5.0 wt.-%.

3. The monophasic propylene-ethylene random copolymer composition (R-PP) according to claim 1, having a crystallization temperature (Tc), determined according to DSC analysis, in the range from 80 to 110° C.

4. The monophasic propylene-ethylene random copolymer composition (R-PP) according to claim 1, having a flexural modulus, determined according to ISO 178 using 80×10×4 mm³ test bars injection moulded in line with ISO 19069-2, in the range from 500 to 1500 MPa.

5. The propylene-ethylene random copolymer (RACO) according to claim 1, having a Charpy notched impact strength (NIS), determined at +23° C. according to ISO 179/leA using 80×10×4 mm³ test bars injection moulded in line with ISO 19069-2, in the range from 5.0 to 20.0 KJ/m².

6. The monophasic propylene-ethylene random copolymer composition (R-PP) according to claim 1, comprising:
i) 40 to 70 wt.-%, relative to the total weight of the monophasic propylene-ethylene random copolymer composition (R-PP), of a first propylene-ethylene random copolymer fraction (R-PP1) having an ethylene content (C2), as determined by ¹³C-NMR spectroscopy, in the range from 0.6 to 4.50 mol-%; and
ii) 30 to 60 wt.-%, relative to the total weight of the monophasic propylene-ethylene random copolymer composition (R-PP), of a second propylene-ethylene random copolymer fraction (R-PP2) having an ethylene content (C2), as determined by ¹³C-NMR spectroscopy, in the range from 0.9 to 9.0 mol-%,
wherein the first propylene-ethylene random copolymer fraction (R-PP1) and the second propylene-ethylene random copolymer fraction (R-PP2) combined make up at least 95 wt.-% of the total weight of the monophasic propylene-ethylene random copolymer composition (R-PP).

7. The monophasic propylene-ethylene random copolymer composition (R-PP) according to claim 6, wherein the ratio of the ethylene content of the monophasic propylene-ethylene random copolymer composition (R-PP) to the ethylene content of the first propylene-ethylene random copolymer fraction (R-PP1), both determined by quantitative ¹³C-NMR spectroscopy and expressed in mol-%, ([C2 (R-PP)]/[C2 (R-PP1)]) is in the range from 1.00 to 3.00.

8. The monophasic propylene-ethylene random copolymer composition (R-PP) according to claim 6, wherein the first propylene-ethylene random copolymer fraction (R-PP1) has a melt flow rate (MFR₂), determined according to ISO 1133 at 230° C. at a load of 2.16 kg, in the range from 0.01 to 4.0 g/10 min; and/or
the second propylene-ethylene random copolymer fraction (R-PP2) has a melt flow rate (MFR₂), determined according to ISO 1133 at 230° C. at a load of 2.16 kg, in the range from 0.01 to 1.00 g/10 min.

9. The monophasic propylene-ethylene random copolymer composition (R-PP) according to claim 7, wherein the ratio of the melt flow rate (MFR₂) of the monophasic propylene-ethylene random copolymer composition (R-PP) to the melt flow rate (MFR₂) of the first propylene-ethylene random copolymer fraction (R-PP1), both determined according to ISO 1133 at 230° C. at a load of 2.16 kg and expressed in g/10 min, ([MFR(R-PP)]/[MFR(R-PP1)]) is in the range from 0.20 to 1.00.

10. A process for obtaining the monophasic propylene-ethylene random copolymer composition (R-PP) according to claim 1, comprising:
a) polymerizing propylene and ethylene comonomer units in a first polymerization reactor in the presence of a single-site catalyst to produce a first polymerization mixture comprising the first propylene-ethylene random copolymer fraction (R-PP1) and the single-site catalyst;
b) withdrawing the first polymerization mixture from the first polymerization reactor and optionally carrying out steps c1) through c3) prior to step d)
c1) transferring the first polymerization mixture into a second polymerization reactor;
c2) polymerizing propylene and ethylene comonomer units in the second polymerization reactor in the presence of the single-site catalyst to produce a second polymerization mixture comprising the first propylene-ethylene random copolymer fraction (R-PP1), the second propylene-ethylene random copolymer fraction (R-PP2) and the single-site catalyst;
c3) withdrawing the second polymerization mixture from the second polymerization reactor; and
d) compounding the first polymerization mixture if steps c1) to c3) are not present, or the second polymerization mixture if steps c1) to c3) are present, optionally with the addition of additives (A).

11. The process according to claim 10, wherein the single site catalyst comprises:
(i) a metallocene complex of the general formula (I) 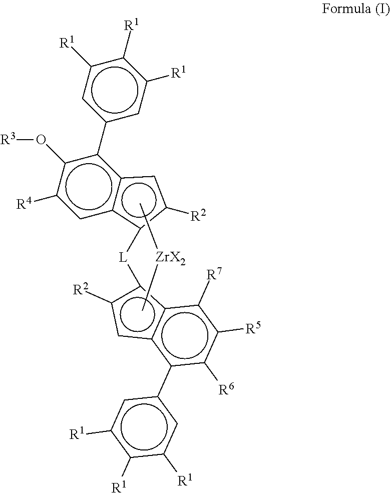
wherein each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C1-10-hydrocarbyl group,
(ii) a co-catalyst system comprising a boron containing co-catalyst and/or an aluminoxane co-catalyst, and
(iii) a silica support.

12. The process according to claim 10, wherein the metallocene complex is selected from the group consisting of rac-dimethylsilanediylbis[2-methyl-4-(3′,5′-dimethylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl] zirconium dichloride,
rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride, and
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

13. The monophasic propylene-ethylene random copolymer composition (R-PP) according to claim 1, wherein the monophasic propylene-ethylene random copolymer composition (R-PP) is obtainable via the process according to claim 10.

14. An article comprising the monophasic propylene-ethylene random copolymer composition (R-PP) according to claim 1 in an amount of at least 75 wt.-%.

15. The article according to claim 14 being a pipe having:
a pipe pressure test stability of at least 20 h (20° C., 16 MPa) following ISO 1167-1 and -2, and/or
a pipe pressure test stability of at least 200 h (95° C., 4.6 MPa) following ISO 1167-1 and -2.
